(19) United States
(12) Patent Application Publication
(10) Pub. No.: US 2012/0315548 A1
(43) Pub. Date: Dec. 13, 2012

(54) LITHIUM SECONDARY BATTERY

(75) Inventors: Masato Fujikawa, Osaka (JP); Tomiki Shiozaki, Osaka (JP)

(73) Assignee: Panasonic Corporation, Osaka (JP)

(21) Appl. No.: 13/580,825

(22) PCT Filed: Dec. 27, 2010
(86) PCT No.: PCT/JP2010/007559

§ 371 Date: Aug. 23, 2012

(30) Foreign Application Priority Data
Feb. 24, 2010 (JP) 2010-039243

(51) Int. Cl. H01M 10/052; H01M 4/134; H01M 10/0569

(52) U.S. Cl. 429/330; 429/326

(57) ABSTRACT

Disclosed is a lithium secondary battery including: a positive electrode, a negative electrode including an alloy-type material, and a non-aqueous electrolyte with lithium ion conductivity. The non-aqueous electrolyte includes a non-aqueous solvent and a lithium salt dissolved in the non-aqueous solvent. The non-aqueous solvent contains a carbonic acid ester, and a sulfinyl compound represented by the general formula (1): R¹—SO—R², where R¹ and R² are independently an alkyl group having one to three carbon atoms. The amount of the sulfinyl compound contained in the non-aqueous solvent is 0.1 to 10 wt %.

### TECHNICAL FIELD

The present invention relates to an improvement of a lithium secondary battery including a negative electrode including an alloy-type material, and particularly relates to an improvement of a non-aqueous electrolyte.

### BACKGROUND ART

With increasing demand for higher capacities of lithium secondary batteries, negative electrodes with high capacities have been developed. Particularly, alloy-type materials used as negative electrode materials have higher capacities than conventionally-used carbon materials (e.g., graphite). Alloy-type materials are materials containing an element capable of forming an alloy with lithium. Silicon and tin are considered promising as an element capable of forming an alloy with lithium. However, an alloy-type material expands and contracts greatly during charge and discharge, and large stress generates in the alloy-type material. Therefore, cracks are likely to occur in the constituent particles of the alloy-type material. Various studies have been made for suppressing the occurrence of cracks (Patent Literature 1).

A lithium secondary battery includes a non-aqueous electrolyte with lithium ion conductivity, and the non-aqueous electrolyte contains a non-aqueous solvent and a lithium salt dissolved in the non-aqueous solvent. For the non-aqueous solvent, a carbonic acid ester is generally used as a major component. It is known that a carbonic acid ester reacts at the surface of the negative electrode, forming a coating of a reaction product on the surface of the negative electrode.

### CITATION LIST

### Patent Literature

[PTL 1] Japanese Laid-Open Patent Publication No. 2007-273184

### SUMMARY OF INVENTION

### Technical Problem

When the negative electrode includes a carbon material, upon passage of the initial stage of charge and discharge, a certain amount of coating derived from a carbonic acid ester is formed on the surface of the negative electrode. After that, the reaction of carbonic acid ester at the surface of the negative electrode is inhibited. On the other hand, when the negative electrode includes an alloy-type material, the expansion and contraction during charge and discharge is so great that cracks are likely to continue to occur in the alloy-type material, until charge and discharge proceed into the final stage. If such cracks are produced, an exposed surface of the alloy-type material is created, and the carbonic acid ester reacts with the exposed surface of the alloy-type material. Therefore, there is a possibility that the reaction involving carbonic acid ester continues until charge and discharge proceed into the final stage, and the reaction product accumulates.

The reaction product derived from a carbonic acid ester includes a one-electron reduction product of carbonic acid ester, such as lithium alkyl carbonate (R—O—CO—O—Li), and a two-electron reduction product of carbonic acid ester, such as Li₂CO₃ and LiF. Among them, Li₂CO₃ and LiF are high in thermal stability, but lithium alkyl carbonate is low in thermal stability. On the other hand, an alloy-type material, in addition to having a high capacity, often contains supplemental lithium corresponding to the irreversible capacity, which has been absorbed therein beforehand. It is considered, therefore, reaction between lithium and lithium alkyl carbonate is likely to occur. If lithium alkyl carbonate accumulates excessively in the negative electrode, the high level of safety of the battery may become difficult to maintain.

### Solution to Problem

The reduction in safety of the battery is presumably caused by the reaction which occurs in the final stage of charge and discharge between the lithium alkyl carbonate accumulated in the negative electrode and the alloy-type material or lithium.

In view of the above, one aspect of the present invention relates to a lithium secondary battery including: a positive electrode including a transition metal oxide capable of absorbing and releasing lithium ions; a negative electrode including an alloy-type material capable of absorbing and releasing lithium ions; and a non-aqueous electrolyte with lithium ion conductivity. The non-aqueous electrolyte includes a non-aqueous solvent and a lithium salt dissolved in the non-aqueous solvent. The non-aqueous solvent contains a carbonic acid ester, and a sulfinyl compound represented by the general formula (1): R¹—SO—R², where R¹ and R² are independently an alkyl group having one to three carbon atoms. The amount of the sulfinyl compound contained in the non-aqueous solvent is 0.1 to 10 wt %.

### Advantageous Effects of Invention

The above-mentioned sulfinyl compound added to a non-aqueous electrolyte with lithium ion conductivity facilitates dissolution of lithium alkyl carbonate into the non-aqueous electrolyte. Therefore, accumulation of lithium alkyl carbonate in the negative electrode can be suppressed. In addition, the safety of the battery in the final stage of charge and discharge (the final stage of battery life) can be improved.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A schematic longitudinal cross-sectional view of a negative electrode in the initial stage of charge and discharge, according to one embodiment of the present invention.

FIG. 2 A schematic longitudinal cross-sectional view of the negative electrode in the final stage of charge and discharge, according to one embodiment of the present invention.

FIG. 3 A schematic longitudinal cross-sectional view of a negative electrode in the initial stage of charge and discharge, according to another embodiment of the present invention.

FIG. 4 An oblique view illustrating a configuration of an exemplary granular body.

FIG. 5 A schematic configuration diagram of an exemplary apparatus for producing a negative electrode.

FIG. 6 A schematic longitudinal cross-sectional view of a lithium secondary battery, according to one embodiment of the present invention.

### DESCRIPTION OF EMBODIMENTS

The lithium secondary battery of the present invention includes: a positive electrode including a transition metal oxide capable of absorbing and releasing lithium ions; a negative electrode including an alloy-type material capable of absorbing and releasing lithium ions; and a non-aqueous electrolyte with lithium ion conductivity. The alloy-type material herein is a material containing an element capable of forming an alloy with lithium. Examples of the element capable of forming an alloy with lithium include silicon, tin, and aluminum. Among them, silicon is preferable because it can provide a high capacity.

The non-aqueous electrolyte includes a non-aqueous solvent and a lithium salt dissolved in the non-aqueous solvent.

The non-aqueous solvent contains, as essential components, a carbonic acid ester and a sulfinyl compound. The amount of the sulfinyl compound contained in the non-aqueous solvent is 0.1 to 10 wt %.

In one preferred embodiment of the present invention, the sulfinyl compound includes dimethylsulfoxide.

In one preferred embodiment of the present invention, the carbonic acid ester includes a cyclic carbonic acid ester and a chain carbonic acid ester.

The amount of the cyclic carbonic acid ester contained in the non-aqueous solvent is preferably 5 to 60 wt %.

The amount of the chain carbonic acid ester contained in the non-aqueous solvent is preferably 30 to 94.9 wt %.

In one preferred embodiment of the present invention, the alloy-type material includes at least one selected from the group consisting of silicon, a silicon compound, and a silicon alloy.

When the silicon compound includes a silicon oxide, the silicon oxide is preferably represented by SiOₓ, where 0.1≦x≦1.5.

When the silicon alloy includes an alloy of silicon and a transition metal Me, the transition metal Me is at least one selected from the group consisting of Ti, Ni, and Cu.

In one preferred embodiment of the present invention, the negative electrode includes a sheet-like negative electrode current collector, and a negative electrode active material layer formed on a surface of the negative electrode current collector. The surface of the negative electrode current collector has a plurality of protrusions. The negative electrode active material layer includes a plurality of granular bodies, and the granular bodies comprise the alloy-type material, and adhere to the tops of the protrusions. The granular bodies each have, for example, a columnar shape or a spherical shape.

Of the granular bodies in the negative electrode, granular bodies adjacent to each other preferably have a gap therebetween.

Each of the granular bodies may be divided into a plurality of granules extending outwardly from the tops of the negative electrode current collector. The granules herein refer to clusters of an alloy-type material each having, for example, a columnar shape or a flaky shape.

In one preferred embodiment of the present invention, Li is supplemented to the battery, in an amount equivalent to 50 to 150%, or more preferably 50 to 100% of the irreversible capacity of the negative electrode. In other words, the negative electrode, in an uncharged state, preferably includes a predetermined amount of lithium. The uncharged state refers to a state in which the state of charge (SOC) is 0%. When the SOC is 0%, the battery voltage is equal to an end-of-discharge voltage. When the SOC is 100% (a fully charged state), the battery voltage is equal to an end-of-charge voltage.

In one preferred embodiment of the present invention, the transition metal oxide included in the positive electrode is an iron-containing oxide having an olivine crystal structure.

A preferred upper limit of the content of the carbonic acid ester relative to the total non-aqueous solvent is 99.9 wt %, 98 wt %, 95 wt %, or 80 wt %, and a preferred lower limit thereof is 10 wt %, 20 wt %, 30 wt %, 35 wt %, or 50 wt %. Any one of the preferred upper limits may be combined with any one of the preferred lower limits. For example, the range of 10 to 99.9 wt %, 20 to 98 wt %, 30 to 95 wt %, or 50 to 80 wt % is preferred.

Examples of the cyclic carbonate include ethylene carbonate (EC), propylene carbonate (PC), butylene carbonate (BC), vinylene carbonate (VC), and vinylethylene carbonate (VEC), but not limited thereto. These may be used singly or in any combination. Among them, EC and PC are preferred in view of the stability and ion conductivity, and PC is particularly preferred because of its low viscosity. Since the chemistry of PC with a carbon material is not so good, PC cannot be used in an amount exceeding a certain level, when the negative electrode mainly includes a carbon material. However, when the negative electrode mainly includes an alloy-type material, there is no such limitation, and PC can be used in a comparatively large amount. Therefore, a non-aqueous solvent that does not contain EC or contains EC in an amount of less than 5 wt % can be used, and thus, the generation of gas derived from EC can be effectively suppressed.

A preferred upper limit of the content of the cyclic carbonic acid ester relative to the total non-aqueous solvent is 80 wt %, 70 wt %, or 60 wt %, and a preferred lower limit thereof is 5 wt %, 10 wt %, or 15 wt %. Any one of the preferred upper limits may be combined with any one of the preferred lower limits. For example, the range of 5 to 80 wt %, 5 to 60 wt %, 10 to 70 wt %, or 15 to 50 wt % is preferred.

A preferred upper limit of the PC content relative to the total non-aqueous solvent is 80 wt %, 50 wt %, or 30 wt %, and a preferred lower limit thereof is 5 wt %, 10 wt %, or 15 wt %. Any one of the preferred upper limits may be combined with any one of the preferred lower limits. For example, the range of 5 to 80 wt %, 10 to 50 wt %, or 15 to 30 wt % is preferred.

In view of forming a stable coating on the surface of the positive or negative electrode, the cyclic carbonic acid ester preferably includes an unsaturated cyclic carbonic acid ester. Preferred unsaturated cyclic carbonic acid esters are VC and VEC. These may be used singly or in combination of two or more. A preferred upper limit of the content of the unsaturated cyclic carbonic acid ester relative to the total non-aqueous solvent is 30 wt %, 10 wt %, or 5 wt %, and a preferred lower limit thereof is 0.1 wt %, 0.5 wt %, or 2 wt %. Any one of the preferred upper limits may be combined with any one of the preferred lower limits. For example, the range of 0.1 to 30 wt %, 0.5 to 10 wt %, or 2 to 5 wt % is preferred.

Examples of the chain carbonate include ethyl methyl carbonate (EMC), dimethyl carbonate (DMC), and diethyl carbonate (DEC), but not limited thereto. These may be used singly or in any combination. Among them, EMC and DEC are preferred in view of the stability and ion conductivity.

A preferred upper limit of the content of the chain carbonic acid ester relative to the total non-aqueous solvent is 94.9 wt %, 85 wt %, or 70 wt %, and a preferred lower limit thereof is 30 wt %, 40 wt %, or 50 wt %. Any one of the preferred upper limits may be combined with any one of the preferred lower limits. For example, the range of 30 to 94.9 wt %, 40 to 85 wt %, or 50 to 70 wt % is preferred.

Examples of components of the non-aqueous solvent other than the carbonic acid ester include dimethoxyethane, γ-butyrolactone, γ-valerolactone, acetonitrile, and fluorobenzene, but not limited thereto.

The non-aqueous solvent contains, as an essential component, a sulfinyl compound represented by the general formula (1): R¹—SO—R², where R¹ and R² are independently an alkyl group having one to three carbon atoms. Examples of the alkyl group having one to three carbon atoms include a methyl group, an ethyl group, an n-propyl group, and an iso-propyl group. These may be used in any combination. Specifically, the sulfinyl compound is exemplified by dimethylsulfoxide, methylethylsulfoxide, diethylsulfoxide, and di-n-propylsulfoxide. These may be used singly or in combination of two or more. Among them, a sulfinyl compound having a methyl group is preferred, and dimethylsulfoxide (DMSO) is particularly preferred, in view of the capability of dissolving lithium alkyl carbonate.

The content of the sulfinyl compound relative to the total non-aqueous solvent is 0.1 to 10 wt %. A preferred upper limit of the content is 8 wt %, 5 wt %, 4 wt %, or 3 wt %, and a preferred lower limit thereof is 0.2 wt %, 0.3 wt %, 0.5 wt %, or 1 wt %. Any one of the preferred upper limits may be combined with any one of the preferred lower limits. For example, the range of 0.2 to 8 wt %, 0.3 to 5 wt %, 0.5 to 4 wt %, or 1 to 3 wt % is preferred. It is particularly preferable that 0.1 to 10 wt % of the total non-aqueous solvent is DMSO. When the content of the sulfinyl compound is less than 0.1 wt %, the effect to improve the safety of the battery in the late stage of battery life is difficult to obtain. When it exceeds 10 wt %, the cycle characteristics tend to deteriorate.

The alloy-type material is not particularly limited, but is preferably at least one selected from the group consisting of silicon (simple substance), a silicon compound, and a silicon alloy, in view of achieving a high capacity. Other preferred examples thereof include tin (simple substance), a tin compound, and a tin alloy. Examples of the silicon compound include a silicon oxide, a silicon nitride, and a silicon oxynitride, but not limited thereto. Examples of the silicon alloy include a silicon-titanium alloy, a silicon-nickel alloy, and a silicon-copper alloy, but not limited thereto.

Particularly preferred among the above-mentioned alloy-type materials is a silicon oxide. In particular, a silicon oxide represented by SiOₓ, where 0.1≦x≦1.5, is preferred because it can effectively reduce the stress due to expansion and contraction. When x is above 1.5, the capacity may become difficult to ensure. When x is below 0.1, the stress due to expansion and contraction becomes comparatively large. A preferred range of x is 0.3 to 1.2, and a particularly preferred range thereof is 0.5 to 1.1. When x is 0.3 or more, the effect to suppress the stress due to expansion and contraction increases. A preferred upper limit of x is 1.5, 1.2, or 1.1, and a preferred lower limit thereof is 0.1, 0.3, or 0.5. Any one of the preferred upper limits may be combined with any one of the preferred lower limits.

The present invention is particularly useful in the case using an alloy-type material in which lithium has been absorbed beforehand in order to compensate the irreversible capacity. This is because the larger the amount of lithium contained in the alloy-type material is, the more the reaction between lithium and lithium alkyl carbonate is likely to occur in the last stage of battery life. Even when the amount of lithium contained in the alloy-type material is large, the above-mentioned sulfinyl compound added to the non-aqueous electrolyte inhibits said reaction, and the safety of the battery is significantly improved. Lithium may be supplemented by any method, but preferably by allowing metal lithium to adhere to the negative electrode active material layer through vapor deposition.

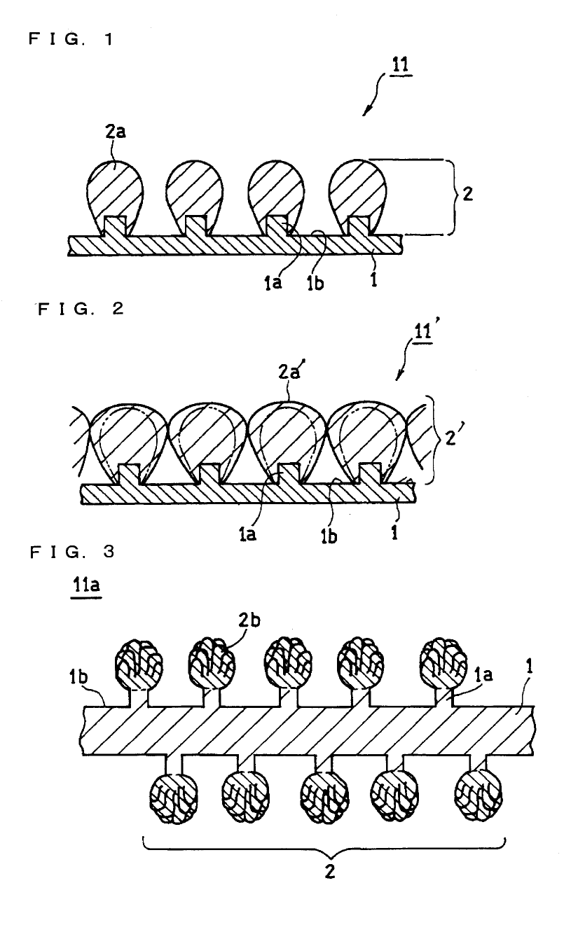

FIG. 1 is a longitudinal cross-sectional view of a negative electrode 11 for a lithium secondary battery in the initial stage of charge and discharge, according to one embodiment of the present invention. The negative electrode 11 includes a sheet-like negative electrode current collector 1 having a plurality of protrusions 1a and a flat portion 1b between the protrusions 1a, and a negative electrode active material layer 2 formed on a surface of the negative electrode current collector 1. The negative electrode active material layer 2 includes a plurality of granular bodies (here, columnar bodies) 2a comprising an alloy-type material absorbing and releasing lithium ions. The protrusions 1a and the negative electrode active material layer 2 may be formed only on one surface of the negative electrode current collector 1 as illustrated in FIG. 1, or may be formed on both surfaces thereof. The “initial stage of charge and discharge” herein refers to a state in which the cumulative number of charge/discharge cycles of a lithium secondary battery including the negative electrode 11 is 20 or less.

FIG. 2 is a longitudinal cross-sectional view of a negative electrode 11′ for a lithium secondary battery in the final stage of charge and discharge, according to one embodiment of the present invention. In the negative electrode 11′, the volume of a plurality of granular bodies 2a′ constituting a negative electrode active material layer 2′ is increased. The volume has increased because cracks have occurred in the granular bodies during charge and discharge, and an exposed surface of the alloy-type material is created. The exposed surface of the alloy-type material has reacted with the components of the non-aqueous electrolyte, to produce reaction products, which have accumulated and increased the volume. The “final stage of charge and discharge” herein refers to a state in which the charge/discharge capacity of a lithium secondary battery including the negative electrode 11 is equal to or less than 50% of the design (rated) capacity.

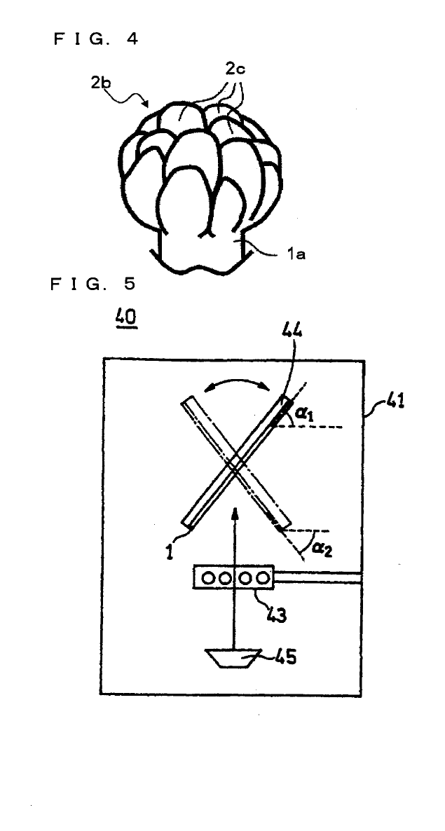

FIG. 3 is a longitudinal cross-sectional view of a negative electrode 11 for a lithium secondary battery in the initial stage of charge and discharge, according to another embodiment of the present invention. As illustrated in FIG. 4, granular bodies 2b are each composed of smaller columnar or flaky granules 2c. Granular bodies configured like this are excellent in that they can easily reduce the stress due to expansion and contraction of the alloy-type material.

The reaction product derived from carbonic acid ester includes a one-electron reduction product of carbonic acid ester (lithium alkyl carbonate: R—O—CO—O—Li) with low thermal stability. Lithium alkyl carbonate dissolves in the sulfinyl compound represented by the general formula (1). Therefore, if lithium alkyl carbonate is produced on the surface of the negative electrode, the lithium alkyl carbonate dissolves in the non-aqueous electrolyte before it accumulates excessively. As a result, the contact area between the alloy-type material and lithium alkyl carbonate decreases, and the reaction between the alloy-type material or lithium and lithium alkyl carbonate is inhibited. Accordingly, the deterioration in thermal stability of the battery can be suppressed.

Next, an exemplary method of producing the negative electrode 11 as illustrated in FIGS. 1 and 2 is described.

The negative electrode 11 can be obtained by depositing an alloy-type material onto the surface of the negative electrode current collector 1 provided with the protrusions 1a, to allow the granular bodies 2a to grow. In order to grow the granular bodies 2a such that their bottoms adhere to the tops of the protrusions 1a, the conditions for deposition are controlled. For example, the shadowing effect is utilized in the vapor deposition, so that the granular bodies can grow as above. The negative electrode current collector 1 can be obtained by, for example, pressing a sheet-like material with a roller whose surface is provided with recesses having a shape corresponding to that of protrusions 1a. Examples of the sheet-like material include a copper foil, a copper alloy foil, and a nickel foil, but not limited thereto.

The height of the protrusions 1a is not particularly limited, but is preferably 3 to 15 μm, and more preferably 5 to 10 μm, when the granular bodies 2a are grown and formed by vapor deposition. When the height of the protrusions 1a is too small, the shadowing effect in the vapor deposition may be difficult to work, and a sufficient volume of gaps may not be formed between the granular bodies 2a. If the volume of the gaps is small, it may be difficult to suppress the expansion and contraction of the alloy-type material.

The shape of the protrusions 1a is not particularly limited, and is, for example, columnar, conical, or trapezoidal. The layout pattern of the protrusions 1a also is not particularly limited, and is desirably a pattern with regularity, such as a lattice pattern or a staggered pattern. The area percentage of the flat portion 1b to the surface of the negative electrode current collector 1 is preferably 30 to 50%, and more preferably 30 to 35%. When the area percentage of the flat portion 1b is too low, the columnar bodies 2a adjacent to each other may not be sufficiently spaced apart from each other. When the area percentage of the flat portion 1b is too high, the shadowing effect in the vapor deposition may be difficult to work.

Next, description is given of the vapor deposition with reference to FIG. 5.

The negative electrode current collector 1 is fixed on a support table 44. A vapor deposition source such as silicon or a silicon oxide is placed in a target 45. The angle α₁ between the surface of the support table 44 and the horizontal direction is adjusted. The angle α₁ is, for example, from 50 to 72°, or from 60 to 65°.

Thereafter, a predetermined gas is allowed to flow from a nozzle 43 at a predetermined rate. The gas used here is, for example, oxygen, nitrogen, or an inert gas. The pressure in the vacuum chamber 41 is adjusted with a vacuum pump (not shown). The accelerating voltage of electron beams to be irradiated to the target is adjusted, and vapor deposition is performed for a predetermined length of time. In such a manner, a first vapor deposition is carried out.

Upon completion of the first vapor deposition, the support table 44 is swung, and the angle α₂ between the surface of the support table 44 and the horizontal direction is adjusted. The angle α₂ is usually set to equal to the angle α₁. In this state, a second vapor deposition is carried out under the same conditions as those in the first vapor deposition. By repeating vapor deposition alternately at the angle α₁ and the angle α₂, the granular bodies 2a being, for example, columnar in shape can be formed on the surface of the negative electrode current collector 1.

Subsequently, metal lithium is vapor deposited on the obtained negative electrode active material layer, so that lithium is supplemented in an amount equivalent to at least part of the irreversible capacity. Given that the irreversible capacity of the negative electrode is denoted by C₀, the amount of lithium to be supplemented is preferably equivalent to 50 to 150%, and more preferably equivalent to 50 to 100% of Cₒ.

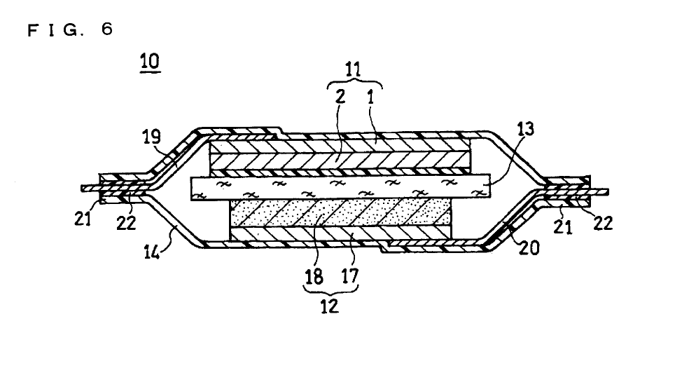

FIG. 6 is a longitudinal cross-sectional view of a lithium secondary battery, according to one embodiment of the present invention.

A battery 10 includes an electrode group including a negative electrode 11, a positive electrode 12, and a separator 13 interposed therebetween, and a non-aqueous electrolyte with lithium ion conductivity. The electrode group and the non-aqueous electrolyte are accommodated in a package case 14. The negative electrode 11 has the negative electrode current collector 1, and the negative electrode active material layer 2 formed on a surface of the negative electrode current collector 1. The positive electrode 12 has a positive electrode current collector 17, and a positive electrode active material layer 18 formed on a surface of the positive electrode current collector 17. One end of a negative electrode lead 19 and one end of a positive electrode lead 20 are connected to the negative electrode current collector 1 and the positive electrode current collector 17, respectively, and the other end of each lead is extended outside the package case 14. The package case 14 is made of a laminated film of resin films and aluminum foil. Openings 21 of the package case 14 are respectively sealed with a resin gasket 22.

The positive electrode includes a positive electrode current collector, and a positive electrode active material layer adhering to a surface thereof. The positive electrode active material layer contains a positive electrode active material as an essential component, and further includes a conductive agent and a binder, as needed. These components are dispersed into an appropriate dispersion medium, to prepare a positive electrode slurry. The slurry is applied onto a surface of the positive electrode current collector, and dried, to form a positive electrode active material layer.

The positive electrode active material may be a transition metal oxide capable of absorbing and releasing lithium ions. The transition metal oxide may be an oxide having a hexagonal crystal structure, a spinel crystal structure, an olivine crystal structure, or the like. Specifically, the transition metal oxide is exemplified by lithium cobalt oxide having a hexagonal crystal structure, lithium nickel oxide having a hexagonal crystal structure, lithium manganese oxide having a spinel crystal structure, or lithium iron phosphate having an olivine crystal structure, but not limited thereto. Particularly preferred among them is lithium iron phosphate having an olivine crystal structure, because it hinders the progress of oxidative decomposition of the sulfinyl compound represented by the formula (1).

Lithium iron phosphate having an olivine crystal structure is represented by the general formula (2): LiₓFe_{1-y}M_{y}PO₄, where M is a metal element other than Li and element Fe, and includes, for example, at least one selected from the group consisting of Co, Mn, Ni, V, Cr, and Cu. When x represents an initial value in a battery before being charged, x satisfies 0.9≦x≦1.2 and coincides with the value of x upon synthesis of lithium iron phosphate. A preferred range of y is 0≦y≦0.2 or 0.05≦y≦0.1. Element M imparts lithium iron phosphate with properties such as improved energy density and improved cycle characteristics.

Lithium iron phosphate having an olivine crystal structure absorbs or releases lithium ions at a comparatively low potential with respect to metal lithium. As such, the positive electrode potential is unlikely to increase excessively, and the oxidative decomposition of the sulfinyl compound represented by the formula (1) is unlikely to occur. Therefore, even in the final stage of charge and discharge, a sufficient amount of sulfinyl compound is retained in the non-aqueous electrolyte, and the effect to improve the battery safety lasts long.

In order to more effectively suppress the oxidative decomposition of the sulfinyl compound at the positive electrode, an additive for forming a stable coating on the positive electrode may be added to the non-aqueous solvent. Preferred examples of the additive include organic sulfonic acid esters and nitryl compounds. Among organic sulfonic acid esters, a sultone compound is preferred, and 1,3-propane sultone is particularly preferred. Among nitryl compounds, succinonitrile is preferred. These additives may be used singly or in combination of two or more. A preferred amount of the additive(s) is, for example, 0.1 to 10 wt % of the total non-aqueous solvent. It is particularly preferable that 0.1 to 10 wt % of the total non-aqueous solvent is 1,3-propane sultone.

The structure of the negative electrode is not limited to those as illustrated in FIGS. 1 to 4, and the negative electrode may be similarly configured as the positive electrode. Specifically, a negative electrode active material layer including an alloy-type material as the negative electrode active material, and further including a conductive agent and a binder, as needed, is allowed to adhere to a surface of the negative electrode current collector.

Examples of the conductive agent included in the positive electrode and the negative electrode include various carbon blacks and various graphites, but not limited thereto. Examples of the binder include fluorocarbon resins, acrylic resins, and particulate rubbers, but not limited thereto. Specifically, the binder is exemplified by polyvinylidene fluoride, polytetrafluoroethylene, tetrafluoroethylene-hexafluoropropylene copolymer, and a particulate rubber having an acrylate unit.

The separator interposed between the positive electrode and the negative electrode and the solute of the non-aqueous electrolyte are not particularly limited, and may be any separator and solute known in the art. Other components of the lithium ion secondary battery are also not particularly limited, and may be any material known in the art.

The present invention is specifically described below by way of Examples, but the present invention is not to be construed as being limited to the following Examples.

### Example 1

### (1) Production of Negative Electrode Current Collector

A 26-μm-thick copper alloy foil (Zr content: 0.02 wt %, available from Hitachi Cable, Ltd.) was pressed between a pair of iron steel rollers, to plastically deform a surface of the copper alloy foil. A negative electrode current collector having a plurality of protrusions on one surface thereof was thus produced. One of the pair of iron steel rollers had a plurality of circular recesses on its surface. The pressing linear pressure was set to 1000 kgf/cm (about 9.81 kN/cm).

The protrusions were formed such that they were arranged in a staggered pattern on the surface of the negative electrode current collector. The protrusions had a columnar shape and were 7 μm in height and 10 μm in diameter. The center-to-center distance between adjacent protrusions was 30 μm. The area percentage of the flat portion in the negative electrode current collector was 30 to 40%.

### (2) Production of Negative Electrode

An alloy-type material was vapor deposited on the surface provided with protrusions of the negative electrode current collector 1 using a vapor deposition apparatus 40 as illustrated in FIG. 5, to form a negative electrode active material layer. Silicon with a purity of 99.9999 wt % was used as a vapor deposition source.

The negative electrode current collector was fixed on the support table 44 of the vapor deposition apparatus 40, and the angle α₁ between the surface of the support table 44 and the horizontal direction was adjusted to 60°. From the nozzle 43, oxygen gas supplied at a flow rate of 400 sccm (25° C.), and He gas was supplied as an inert gas at a flow rate of 80 sccm (25° C.), into the vacuum chamber 41. The pressure in the vacuum chamber 41 was adjusted to be 7×10⁻³ Pa (abs) before introduction of He gas, and then to be 5×10⁻² Pa (abs) by introduction of He gas. The accelerating voltage and emission of electron beams were set to −8 kV and 500 mA, respectively, and a first vapor deposition was performed for 300 seconds. As a result of the first vapor deposition, a film having a thickness of 2.5 μm was formed on the protrusions of the negative electrode current collector.

Upon completion of the first vapor deposition, the support table 44 was swung, and the angle α₂ between the surface of the support table 44 and the horizontal direction was adjusted to 60°. A second vapor deposition was carried out under the same conditions as those in the first vapor deposition. Similar vapor deposition to the first and second vapor deposition was repeated, and vapor deposition was performed eight times in total. The negative electrode active material layer thus obtained was composed of granular bodies of SiOₓ, where x=1.2. The height of the granular bodies and the maximum diameter of the perimeter of the granular bodies as measured immediately after vapor deposition were about 20 μm and about 25 μm, respectively. There was a gap between adjacent granular bodies. Subsequently, metal lithium was vapor deposited on the negative electrode active material layer in an amount equivalent to 100% of the irreversible capacity.

### (3) Production Positive Electrode

To 100 parts by weight of lithium cobalt oxide (LiCoO₂) having an average particle size of 5 μm, 3 parts by weight of acetylene black serving as a conductive agent, 4 parts by weight of polyvinylidene fluoride (PVdF) serving as a binder, and an appropriate amount of N-methyl-2-pyrrolidone were added and mixed, to give a positive electrode slurry. The positive electrode slurry was applied onto one surface of a 15-μm-thick positive electrode current collector made of an aluminum foil, dried and rolled, to form a positive electrode active material layer. The thickness of the positive electrode active material layer was set to 85 μm.

### (4) Non-Aqueous Electrolyte

LiPF₆ was dissolved in a non-aqueous solvent containing EC, EMC, DEC, and a predetermined sulfinyl compound in a weight ratio of 37:30:30:3 (100 in total), to prepare a non-aqueous electrolyte. The concentration of LiPF₆ was set to 1 mol/L. Dimethylsulfoxide (DMSO: Example 1A), methylethylsulfoxide (MESO: Example 1B), diethylsulfoxide (DESO: Example 1C), and di-n-propylsulfoxide (DPSO: Example 1D) were used as the sulfinyl compound.

### (5) Fabrication of Lithium Secondary Battery

The negative electrode and the positive electrode were laminated with a polyethylene porous film (trade name: Hipore, thickness: 20 μm, available from Asahi Kasei Corporation) interposed therebetween as a separator, to form an electrode group. To the exposed portions of the negative and positive electrode current collectors, one end of a negative electrode lead being made of nickel and provided with a polyethylene tab, and one end of a positive electrode lead being made of aluminum and provided with a polyethylene tab were welded, respectively. The electrode group was then inserted into a package case. The tabs of the negative and positive electrode leads were positioned at the openings of the package case, and the other end of each lead was extended outside. The non-aqueous electrolyte was injected into the package case, and then, the openings of the package case were sealed by welding under reduced pressure. A lithium secondary battery as illustrated in FIG. 6 was thus obtained.

### Comparative Example 1

A non-aqueous electrolyte was prepared and a battery was fabricated in the same manner as in Example 1, except that no sulfinyl compound was contained in the non-aqueous solvent, and a non-aqueous solvent containing EC, EMC, and DEC in a weight ratio of 40:30:30 (100 in total) was used.

### Evaluation

### (1) Cycle Characteristics

Each battery was subjected to charge/discharge cycles at 45° C., each cycle consisting of the following (a) to (d).

(a) Constant-current and constant-voltage charge: Maximum current 600 mA, upper limit voltage 4.2 V, cut-off current 50 mA

(b) Interval for 10 minutes after charge

(c) Constant-current discharge: Discharging current 850 mA, discharge cut-off voltage 2.5 V

(d) Interval for 10 minutes after discharge

The discharge capacity at the 3rd cycle was defined as 100%, and the number of cycles (cycles) when the discharge capacity reached 50% was determined. The results are shown in Table 1.

### (2) Safety

Upon evaluation of the cycle characteristics, the battery was charged again and allowed to stand in a constant-temperature bath at 130° C. for 3 hours, to see whether the battery temperature increased or not. The maximum temperature is shown in Table 1.

As clear from Table 1, the battery safety greatly differs depending on the presence or absence of the sulfinyl compound. It should be noted that no such great difference in safety is observed, for example, in a battery including a carbon material such as graphite as a negative electrode active material.

TABLE 1

| | Number of cycles | Maximum temperature |
|---|---|---|
| Sulfinyl compound | (cycles) | (° C.) |
| DMSO (Ex. 1A) | 340 | 135 |
| MESO (Ex. 1B) | 328 | 133 |
| DESO (Ex. 1C) | 355 | 138 |
| DPSO (Ex. 1D) | 348 | 133 |
| Without (Com. Ex. 1) | 350 | 165 |

A battery (Example 1E) was fabricated and evaluated in the same manner as in Example 1A, except that metal lithium for compensating the irreversible capacity was not vapor deposited on the negative electrode active material layer.

A battery (Comparative Example 1b) was fabricated and evaluated in the same manner as in Example 1E, except that no sulfinyl compound was contained in the non-aqueous solvent, and a non-aqueous solvent containing EC, EMC, and DEC in a weight ratio of 40:30:30 (100 in total) was used. The results are shown in Table 2.

TABLE 2

| | Number of cycles | Maximum temperature |
|---|---|---|
| Sulfinyl compound | (cycles) | (° C.) |
| DMSO (Ex. 1E) | 219 | 138 |
| Without (Com. Ex. 1b) | 230 | 140 |

As clear from Table 2, in the case of not vapor depositing metal lithium for compensating the irreversible capacity of the negative electrode, as compared with in the case of vapor depositing metal lithium, the effect obtained by adding a sulfinyl compound to improve the safety was small. This indicates that the effect of a sulfinyl compound is evident in the case of compensating the irreversible capacity.

Next, graphite was used as a negative electrode active material, and a negative electrode was produced in the following manner.

To 100 parts by weight of natural graphite particles having an average particle size of 18 μm, 1 part by weight of carboxymethyl cellulose (CMC) serving as a thickener, 0.6 parts by weight of styrene-butadiene rubber (SBR) serving as a binder, and an appropriate amount of water were added and mixed, to give a negative electrode slurry. The negative electrode slurry was applied onto one surface of a 10-μm-thick negative electrode current collector made of a copper foil, dried and rolled, to form a negative electrode active material layer (density of graphite: 1.6 g/cm). The thickness of the negative electrode active material layer was set to 68 μm.

A battery (Comparative Example 1c) was fabricated and evaluated in the same manner as in Example 1A, except that the obtained negative electrode was used.

A battery (Comparative Example 1d) was fabricated and evaluated in the same manner as in Comparative Example 1b, except that no sulfinyl compound was contained in the non-aqueous solvent, and a non-aqueous solvent containing EC, EMC, and DEC in a weight ratio of 40:30:30 (100 in total) was used. The results are shown in Table 3.

TABLE 3

| | Negative | Number of | Maximum |
|---|---|---|---|
| | electrode | cycles | temperature |
| Sulfinyl compound | active material | (cycles) | (° C.) |
| DMSO (Ex. 1c) | Graphite | 415 | 126 |
| Without (Com. Ex. 1d) | Graphite | 408 | 132 |

As clear from Table 3, in the case of using graphite as the negative electrode active material, regardless of with or without a sulfinyl compound, the maximum temperature was around 130° C., and no reduction in safety in the final stage of charge and discharge was observed. This indicates that a reduction in safety in the final stage of charge and discharge as observed in the case of using an alloy-type material is a problem peculiar to alloy-type materials.

### Example 2

A non-aqueous electrolyte was prepared and a battery was fabricated and evaluated in the same manner as in Example 1A, except that the weight ratio of EC, EMC, DEC, and DMSO was changed as shown in Table 3. The results are shown in Table 4.

TABLE 4

| Weight ratio | Number of | Maximum |
|---|---|---|
| EC:EMC:DEC:DMSO | cycles | temperature |
| (100 in total) | (cycles) | (° C.) |
| 39.95:30:30:0.05 (Com. Ex. 2a) | 346 | 162 |
| 39.9:30:30:0.1 (Ex. 2A) | 343 | 138 |
| 39.5:30:30:0.5 (Ex. 2B) | 345 | 137 |
| 39:30:30:1 (Ex. 2C) | 339 | 135 |
| 37:30:30:3 (Ex. 2D) | 340 | 135 |
| 35:30:30:5 (Ex. 2E) | 341 | 135 |
| 32:30:30:8 (Ex. 2F) | 338 | 131 |
| 30:30:30:10 (Ex. 2G) | 332 | 132 |
| 25:30:30:15 (Com. Ex. 2b) | 277 | 132 |
| 20:30:30:20 (Com. Ex. 2c) | 250 | 131 |

### Example 3

A battery was fabricated and evaluated in the same manner as in Example 1A, except that the value x in SiOₓ forming the granular bodies was changed as shown in Table 5. The results are shown in Table 5. The value x was changed by changing the flow rates of oxygen gas and He gas introduced into the vacuum chamber from the nozzle 43, in forming a negative electrode active material layer.

TABLE 5

| | Number of cycles | Maximum temperature |
|---|---|---|
| Value X | (cycles) | (° C.) |
| 0.1 | 315 | 138 |
| 0.3 | 325 | 139 |
| 0.5 | 330 | 140 |
| 1.0 | 332 | 137 |
| 1.2 (Ex. 1A) | 340 | 135 |
| 1.5 | 370 | 133 |

### Example 4

Alloys as shown in Table 6 were prepared by mechanical alloying: Fe—Si alloy (Fe: 37 wt %, Si: 63 wt %), Co—Si alloy (Co: 38 wt %, Si: 62 wt %), Ni—Si alloy (Ni: 38 wt %, Si: 62 wt %), Cu—Si alloy (Cu: 39 wt %, Si: 61 wt %), Ti—Si alloy (Ti: 26 wt %, Si: 74 wt %), Ti—Sn alloy (Ti: 26 wt %, Sn: 74 wt %), and Cu—Sn alloy (Cu: 31 wt %, Sn: 69 wt %).

To 70 parts by weight of the prepared alloy powder (average particle size: 10 μm), 10 parts by weight of ethylene-acrylic acid copolymer serving as a binder, 20 parts by weight of acetylene black, and an appropriate amount of water were added and mixed, to prepare a negative electrode slurry. The negative electrode slurry was applied onto one surface of a 12-μm-thick rolled copper foil, dried and rolled, to form a negative electrode active material layer. A battery was fabricated and evaluated in the same manner as in Example 1A, except that the negative electrode thus obtained was used. The same battery as that of Example 4A except for not containing DMSO was evaluated as Comparative Example 4. The results are shown in Table 6.

TABLE 6

| | Number of cycles | Maximum temperature |
|---|---|---|
| Alloy | (cycles) | (° C.) |
| Fe—Si (Ex. 4A) | 280 | 136 |
| Co—Si (Ex. 4B) | 300 | 138 |
| Ni—Si (Ex. 4C) | 312 | 134 |
| Cu—Si (Ex. 4D) | 301 | 135 |
| Ti—Si (Ex. 4E) | 321 | 137 |
| Ti—Sn (Ex. 4F) | 295 | 136 |
| Cu—Sn (Ex. 4G) | 292 | 139 |
| Fe—Si (Com. Ex. 4) | 315 | 159 |

### Example 5

To 100 parts by weight of lithium iron phosphate (LiFe_{1-y}M_{y}PO₄) shown in Table 7, 3 parts by weight of acetylene black serving as a conductive agent, 4 parts by weight of polyvinylidene fluoride (PVdF) serving as a binder, and an appropriate amount of N-methyl-2-pyrrolidone were added and mixed, to prepare a positive electrode slurry. The positive electrode slurry was applied onto one surface of a 15-μm-thick positive electrode current collector made of an aluminum foil, dried and rolled, to form a positive electrode active material layer. The thickness of the positive electrode active material layer was set to 85 μm. A battery was fabricated in the same manner as in Example 1A, except that the positive electrode thus obtained was used, and the battery was evaluated. The results are shown in Table 7.

In the evaluation, the conditions for charge/discharge cycles were changed as follows.

(a) Constant-current and constant-voltage charge: Maximum current 600 mA, upper limit voltage 3.8 V, cut-off current 50 mA

(b) Interval for 10 minutes after charge

(c) Constant-current discharge: Discharging current 850 mA, discharge cut-off voltage 2.5 V

(d) Interval for 10 minutes after discharge

The same battery as that of Example 5A except for containing 1,3-propane sultone as an additive for forming a coating on the positive electrode in the non-aqueous electrolyte was evaluated as Example 5E. The amount of the additive was set to 3 wt % of the total non-aqueous solvent.

The same battery as that of Example 5A except for not containing DMSO was evaluated as Comparative Example 5.

TABLE 7

| | Number of cycles | Maximum temperature |
|---|---|---|
| Lithium ion phosphate | (cycles) | (° C.) |
| LiFePO₄ (Ex. 5A) | 325 | 132 |
| LiFe_{0.8}Co_{0.2}PO₄ (Ex. 5B) | 328 | 134 |
| LiFe_{0.8}Mn_{0.2}PO₄ (Ex. 5C) | 335 | 137 |
| LiFe_{0.8}Ni_{0.2}PO₄ (Ex. 5D) | 352 | 136 |
| LiFePO₄ (Ex. 5E) | 387 | 135 |
| LiFePO₄ (Com. Ex. 5) | 338 | 157 |

The results of Tables 1 to 7 show that in the case where the negative electrode includes an alloy-type material, the inclusion of a predetermined sulfinyl compound in the non-aqueous electrolyte is effective in improving the safety of the battery.

### INDUSTRIAL APPLICABILITY

The lithium secondary battery of the present invention is useful as a power source for electronic devices such as cellular phones, personal computers, and digital still cameras, and more useful as a power source for electric vehicles and hybrid vehicles. The application thereof, however, is not limited to them.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

1 Negative electrode current collector
1a Protrusion
1b Flat portion
2 Negative electrode active material layer
2a Columnar body
10 Battery
11 Negative electrode
12 Positive electrode
13 Separator
14 Package case
17 Positive electrode current collector
18 Positive electrode active material layer
19 Negative electrode lead
20 Positive electrode lead
21 Opening
22 Resin gasket
40 Vapor deposition apparatus
41 Vacuum chamber
43 Nozzle
44 Support table
45 Target

1. A lithium secondary battery comprising:
a positive electrode including a transition metal oxide capable of absorbing and releasing lithium ions;
a negative electrode including an alloy-type material capable of absorbing and releasing lithium ions,
the negative electrode including a sheet-like negative electrode current collector, and a negative electrode active material layer formed on a surface of the negative electrode current collector, the surface of the negative electrode current collector having a plurality of protrusions, the negative electrode active material layer including a plurality of granular bodies, the granular bodies comprising the alloy-type material, and adhering to tops of the protrusions; and
a non-aqueous electrolyte with lithium ion conductivity, wherein
lithium is supplemented, in an amount equivalent to 50 to 150% of an irreversible capacity of the negative electrode,
the non-aqueous electrolyte includes a non-aqueous solvent and a lithium salt dissolved in the non-aqueous solvent,
the non-aqueous solvent contains a carbonic acid ester, and a sulfinyl compound represented by the general formula (1):
R¹—SO—R²,
where R¹ and R² are independently an alkyl group having one to three carbon atoms, and
an amount of the sulfinyl compound contained in the non-aqueous solvent is 0.1 to 10 wt %.

2. The lithium secondary battery in accordance with claim 1, wherein the sulfinyl compound includes dimethylsulfoxide.

3. The lithium secondary battery in accordance with claim 1, wherein
the carbonic acid ester includes a cyclic carbonic acid ester and a chain carbonic acid ester,
an amount of the cyclic carbonic acid ester contained in the non-aqueous solvent is 5 to 60 wt %, and
an amount of the chain carbonic acid ester contained in the non-aqueous solvent is 30 to 94.9 wt %.

4. The lithium secondary battery in accordance with claim 1, wherein the alloy-type material includes at least one selected from the group consisting of silicon, a silicon compound, and a silicon alloy.

5. The lithium secondary battery in accordance with claim 4, wherein the silicon compound includes a silicon oxide, and the silicon oxide is represented by SiOₓ, where 0.1≦x≦1.5.

6. The lithium secondary battery in accordance with claim 4, wherein the silicon alloy includes an alloy of silicon and a transition metal Me, the transition metal Me is at least one selected from the group consisting of Ti, Ni, and Cu.

7. (canceled)

8. The lithium secondary battery in accordance with claim 1, wherein the granular bodies adjacent to each other have a gap therebetween, and each of the granular bodies is divided into a plurality of granules extending outwardly from each of the tops of the negative electrode current collector.

9. (canceled)

10. The lithium secondary battery in accordance with claim 1, wherein the transition metal oxide is an iron-containing oxide having an olivine crystal structure.
